(19) United States
(12) Patent Application Publication
(10) Pub. No.: US 2026/0185697 A1
(43) Pub. Date: Jul. 2, 2026

(54) INDUSTRIAL BOILER CONTROL METHOD USING STATISTICAL DATA ACCORDING TO COMBUSTION STAGE CHANGE

(71) Applicant: Korea Electronics Technology Institute, Seongnam-si (KR)

(72) Inventors: Seung Hyeon PARK, Yongin-si (KR); Ki Woong KWON, Seoul (KR); Young Ho KIM, Incheon (KR); Sang Hun KIM, Suwon-si (KR)

(73) Assignee: Korea Electronics Technology Institute, Seongnam-si (KR)

(21) Appl. No.: 19/424,305

(22) Filed: Dec. 18, 2025

(30) Foreign Application Priority Data
Dec. 26, 2024 (KR) 10-2024-0196428

(51) Int. Cl. F22B 35/00; G05D 16/20

(52) U.S. Cl. CPC F22B 35/00; G05D 16/20

(57) ABSTRACT

Provided is an industrial boiler control method using statistical data according to changes in combustion stages. A boiler control method according to an embodiment may include: collecting operation data of each boiler with respect to a plurality of boilers; calculating an operation efficiency of each boiler based on the operation data; generating statistical data of each boiler according to changes in combustion stages from the operation data; and controlling a pressure of each boiler to optimize an objective function having the operation efficiency and the statistical data as parameters. Accordingly, efficiencies of boilers may be prevented from being degraded due to frequent changes in combustion stages for the reason of a position connected to a steam header, and ultimately, energy consumption required for operating boilers may be reduced.

### CROSS-REFERENCE TO RELATED APPLICATION(S) AND CLAIM OF PRIORITY

This application is based on and claims priority under 35 U.S.C. § 119 to Korean Patent Application No. 10-2024-0196428, filed on Dec. 26, 2024, in the Korean Intellectual Property Office, the disclosure of which is herein incorporated by reference in its entirety.

### BACKGROUND

### Field

The disclosure relates to an industrial boiler operation control technology, and more particularly, to a method for statistically utilizing changes in combustion stages in addition to operation efficiencies when controlling pressures of boilers.

### Description of Related Art

Indusrial boilers are operated by dividing combustion stages with reference to pressures (steam pressures). Produced steam is difficult to store due to its characteristics and production and consumption of steam are simultaneously performed, and pressure changes according to consumption, and boilers are operated in response to consumption while changing combustion stages accordingly.

This operation pattern may cause unnecessary fluctuations in combustion stages depending on consumption, and, according to circumstances, some boilers may be frequently turned on/off. In addition, several boilers may be installed by being connected to one steam header, and a boiler located close to the outlet of the steam header should react to change in pressure, first, compared to other boilers, and may have relatively more frequent fluctuations in combustion stages.

Currently, these field characteristics are reflected on setting of appropriate pressure standards by experience. However, it is still difficult to control pressure appropriately when considering the same settings for several boilers, load variability and boiler aging, and on-site operation efficiency.

### SUMMARY

The disclosure has been developed in order to solve the above-described problems, and an object of the disclosure is to provide, as a solution to prevent operation efficiencies of boilers from being reduced by frequent changes in combustion stages, a method and a system for controlling pressures of industrial boilers by further using statistical data according to changes in combustion stages, in addition to operation efficiencies.

According to an embodiment of the disclosure to achieve the above-described object, a boiler control method may include: collecting operation data of each boiler with respect to a plurality of boilers; calculating an operation efficiency of each boiler based on the operation data; generating statistical data of each boiler according to changes in combustion stages from the operation data; and controlling a pressure of each boiler to optimize an objective function having the operation efficiency and the statistical data as parameters.

The boilers may be connected to a single steam header. The operation data may include an operating time, a combustion stage, cumulative water supply, cumulative fuel consumption, a pressure.

Calculating may include calculating the operation efficiency for each unit time of each boiler based on the following equation:

$$Boiler Operation Efficiency = ( Cumulative Water Supply for Unit Time ) / ( Cumulative Fuel Consumption for Unit Time ) .$$

Generating may include generating the number of operation cycles in each combustion stage of each boiler and a duration of each operation cycle in each combustion stage of each boiler.

The operation cycle may be a period from when a combustion stage of a boiler changes from a previous combustion stage to when the combustion stage changes to a next combustion stage, the number of operation cycles in each combustion stage may be the number of operation cycles counted for each combustion stage, and the duration may be a time during which an operation cycle remains unchanged.

The objective function may increase when a total operation efficiency for each unit time in each combustion stage of each boiler increases, and may decrease when a variance of the numbers of operation cycles in each combustion stage of each boiler increases.

The objective function may increase when a total operation efficiency for each unit time in each combustion stage of each boiler increases, and may decrease when a variance of the durations of each operation cycle in each combustion stage of each boiler increases.

According to an embodiment, the boiler control method may further include pre-processing the collected operation data.

According to another aspect of the disclosure, there is provided a boiler control server including: a communication unit configured to collect operation data of each boiler with respect to a plurality of boilers; and a processor configured to calculate an operation efficiency of each boiler based on the operation data, to generate statistical data of each boiler according to changes in combustion stages from the operation data, and to control a pressure of each boiler to optimize an objective function having the operation efficiency and the statistical data as parameters.

According to still another aspect of the disclosure, there is provided a boiler control method including: collecting operation data of each boiler with respect to a plurality of boilers; generating the number of operation cycles in each combustion stage of each boiler from the operation data of each boiler; generating a duration of each operation cycle in each combustion stage of each boiler from the operation data of each boiler; and controlling a pressure of each boiler, based on the number of operation cycles in each combustion state of each boiler and the duration of each operation cycle in each combustion state of each boiler.

As described above, according to embodiments of the disclosure, by controlling pressures of industrial boils by further using statistical data according to changes in combustion stages in addition to operation efficiencies, operation efficiencies of boilers may be prevented from being degraded due to frequent changes in the combustion stages for the reason of a position connected to a steam header, and ultimately, energy consumption required for operating the boilers may be reduced.

In particular, according to embodiments of the disclosure, based on statistical data according to changes in combustion stages, it can be understood in the field how boilers are operated and how operation efficiencies of boilers are changed, and, when there are a plurality of boilers, the efficiency of an individual boiler may be enhanced, and uniform operation and performance maximation may be realized by preventing excessive operation of a specific boiler in the entire steam production.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating an industrial boiler control system according to an embodiment of the disclosure;

FIG. 2 is a view illustrating an industrial boiler control method according to another embodiment of the disclosure;

FIGS. 3A to 3C are views illustrating examples of the number of operation cycles in each combustion stage of each boiler and a duration of each operation cycle in each combustion stage;

FIGS. 4A to 4C are views illustrating examples of the number of operation cycles in each combustion stage of each boiler and a duration of each operation cycle in each combustion stage;

FIG. 5 is a view illustrating a boiler control server shown in FIG. 1

### DETAILED DESCRIPTION

Hereinafter, the disclosure will be described in more detail with reference to the accompanying drawings.

Embodiments of the disclosure propose an industrial boiler control method using statistical data according to changes in combustion stages. The disclosure relates to a technology for controlling pressures (steam pressures) of industrial boilers by further using statistical data according to changes in combustion stages in addition to boiler operation efficiencies.

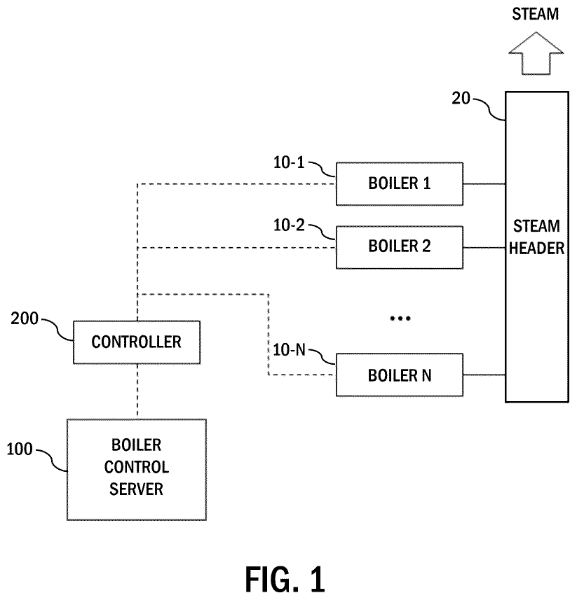

FIG. 1 is a view illustrating a configuration of an industrial boiler control system according to an embodiment of the disclosure. The industrial boiler control system according to an embodiment may include a boiler control server 100 and a controller 200.

Boilers 10-1, 10-2, . . . , 10-N may be connected to one common steam header 20. The boilers 10-1, 10-2, . . . , 10-N may be connected to the steam header 20 at different positions, respectively.

The boiler control server 100 may collect operation data of the boilers 10-1, 10-2, . . . , 10-N, may calculate operational efficiencies and generate statistical data according to changes in combustion stages, and may adjust pressures of the boilers 10-1, 10-2, . . . , 10-N, respectively, based on the operation efficiencies and the statistical data.

The controller 200 may control actual operations of the boilers 10-1, 10-2, . . . , 10-N according to pressures adjusted by the boiler control server 100.

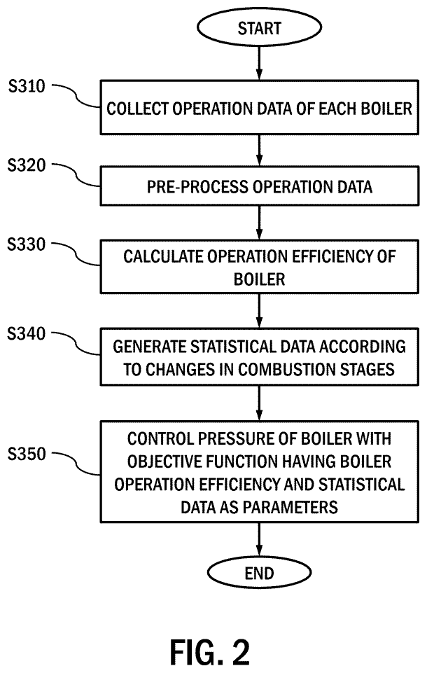

Hereinafter, a process of adjusting/controlling pressures of the boilers 10-1, 10-2, . . . , 10-N by the boiler control server 100/controller 200 will be described in detail with reference to FIG. 2. FIG. 2 is a flowchart of an industrial boiler control method according to another embodiment of the disclosure.

As shown in FIG. 2, the boiler control server 100 may collect operation data for each of the boilers 10-1, 10-2, . . . , 10-N (S310). Operation data may be collected through IoT devices installed in the boilers 10-1, 10-2, . . . , 10-N. Operation data collected may include a boiler number (boiler identifier), an operating time, a combustion stage, cumulative water supply, cumulative fuel consumption, pressure, etc.

The boiler control server 100 may perform pre-processing with respect to the operation data collected at step S310 (S320). Specifically, the boiler control server 100 may process the operation data of each boiler 10-1, 10-2, . . . , 10-N to synchronize and to match a time interval to a unit time (1 minute).

Specifically, the boiler control server 100 may convert cumulative water supply and cumulative fuel consumption into second-based cumulative water supply and second-based cumulative fuel consumption, and then may add up them in the unit of minute, thereby processing cumulative water supply and cumulative fuel consumption in the unit time. The pressure may be processed as a median value existing at the highest portion among various pressure values existing within the unit time.

The boiler control server 100 may calculate a boiler operation efficiency for each boiler at unit-time intervals (1 minute) (S330). The boiler operation efficiency may be calculated by the following Equation 1:

$$Boiler Operation Efficiency = ( Cumulative Water Supply for Unit Time ) / ( Cumulative Fuel Consumption for Unit Time ) \qquad Equation 1$$

The boiler control server 100 may generate statistical data according to changes in combustion stages by using an operating time and a combustion stage of operation data collected at step S310 (S340). The statistical data may include the number of operation cycles in each combustion stage of each boiler and a duration of each operation cycle in each combustion stage.

The operation cycle refers to a period from when a combustion stage of a boiler changes from a previous combustion stage to when the combustion stage changes to a next combustion stage, and the number of operation cycles in each combustion stage refers to the number of operation cycles counted for each combustion stage. The duration refers to a time during which an operation cycle remains unchanged, and may be calculated for each operation cycle.

For example, when boiler 1 10-1 is operated in sequence of “starting→operating for 30 minutes at the first stage→changing to the second stage and operating for 50 minutes→changing to the third stage and operating for 40 minutes→changing back to the second stage and operating for 60 minutes→terminating”, the number of operation cycles in each combustion stage and the duration of each operation cycle in each combustion stage of boiler 1 10-1 are as follows:
First stage=>the number of operation cycles: 1, duration: 30 minutes,
Second stage=>the number of operation cycles: 2, duration: 50 minutes, 60 minutes,
Third stage=>the number of operation cycles: 1, duration: 40 minutes.

The number of operation cycles in each combustion stage and the duration of each operation cycle in each combustion stage may tell how many times and how long a corresponding boiler is operated in a corresponding combustion stage.

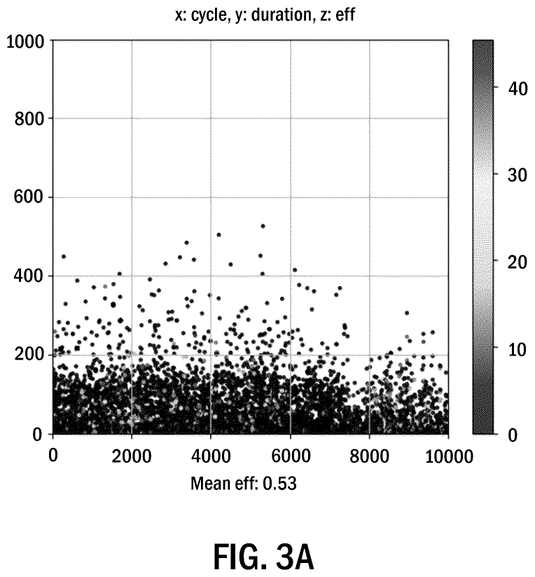

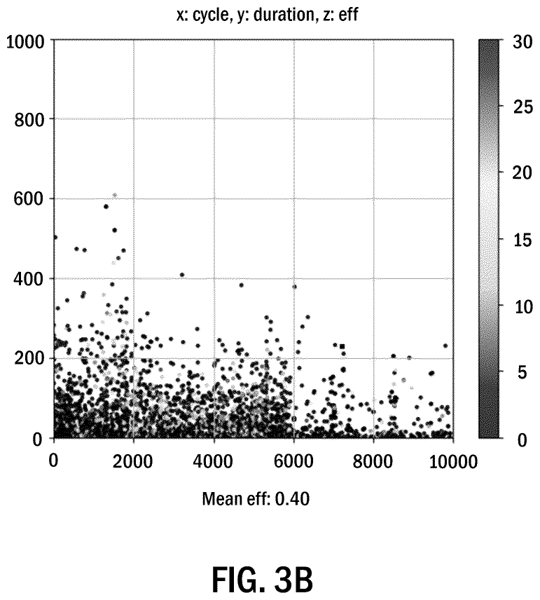

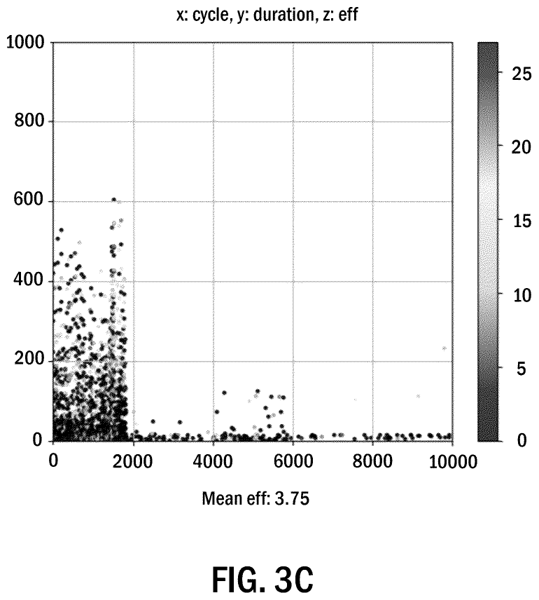

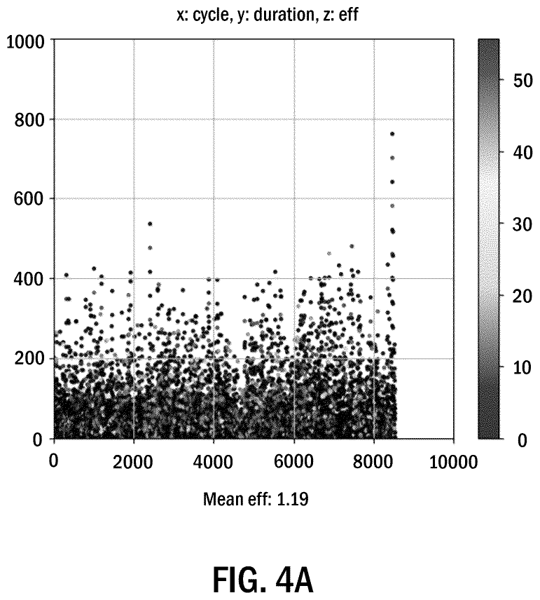

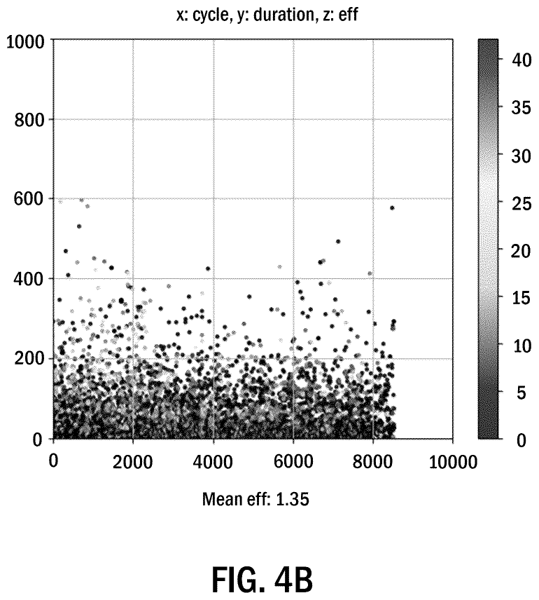

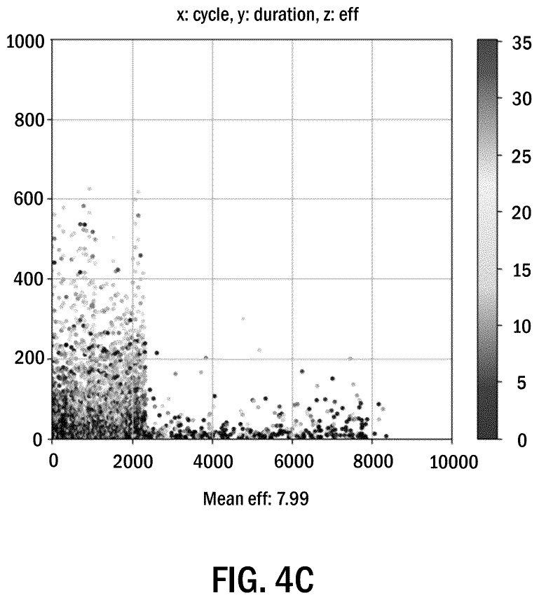

The number of operation cycles in each combustion stage and the durations of each operation cycle in each combustion stage of each boiler, which are generated at step S340, are illustrated in FIGS. 3A to 3C and FIGS. 4A to 4C.

FIGS. 3A to 3C depict graphs illustrating the number of operation cycles in each combustion stage and the duration of each operation cycle in each combustion stage of boiler 1 10-1 for 2 months. FIG. 3A shows the number of operation cycles and the duration in the first stage, FIG. 3B shows the number of operation cycles and the duration in the second stage, and FIG. 3C shows the number of operation cycles and the duration in the third stage. In each graph, the x-axis indicates operation cycles, the y-axis indicates duration, and the z-axis (gray scale) indicate boiler operation efficiencies. Mean eff at the bottom of each graph indicates an average of boiler operation efficiencies in a corresponding combustion stage.

FIGS. 4A to 4C depict graphs illustrating the number of operation cycles in each combustion stage and the duration of each operation cycle in each combustion stage of boiler 2 10-2 which has the same capacity as boiler 1 10-1 for the same period. Combustion stages of FIGS. 4A to 4C, the axes of the graphs, and the parameter indicated by Mean eff are the same as those in FIGS. 3A to 3C.

Comparing FIGS. 3A to 3C and FIGS. 4A to 4C, the number of operation cycles of boiler 1 10-1 is larger than the number of operation cycles of boiler 2 10-2 in all combustion stages. In addition, the duration of boiler 1 10-1 is shorter than the duration of boiler 2 10-2 in all combustion stages. Since the total operating time is the same, it is natural that, as the number of operation cycles is larger, the duration is shorter.

It can be seen from the graphs that boiler 1 10-1 more frequently experiences changes in combustion stages than boiler 2 10-2. This is because boiler 1 10-1 is located closer to the outlet of the steam header 20 than boiler 2 10-2.

Meanwhile, comparing the boiler operation efficiency averages in each combustion stage, it can be seen that the operation efficiency average of boiler 1 10-1 is lower than the operation efficiency average of boiler 2 10-2 in all combustion stages. This shows that the frequent changes in combustion stages adversely affects the boiler operation efficiency.

Accordingly, it is necessary to reduce the frequent changes in combustion stages due to a position of a boiler connected to the steam header 20 like boiler 1 10-1. The result comes to the conclusion that it is effective to uniformly manage the number of operation cycle in each combustion stage and the duration of each operation cycle.

Hence, the boiler control server 100 may optimize in a direction that increases an objective function having statistical data according changes in combustion as a parameter, in addition to boiler operation efficiencies, and adjusts the pressure of each boiler 10-1, 10-2, . . . , 10-N, and the controller 200 may control the pressure of each boiler 10-1, 10-2, . . . , 10-N accordingly (S350). In optimizing, a mixed integer nonlinear programming (MINLP) optimization technique may be utilized. The objective function may be expressed by the following Equation 2:

$$Objective function = α \times E - β \times C - γ \times D \qquad Equation 2$$

where E is the total operation efficiency for each unit time in each combustion stage of each boiler, C is a variance of the numbers of operation cycles in each combustion stage of each boiler, D is a variance of durations of each operation cycle in each combustion stage of each boiler, α+β+γ=1, minimum pressure<pressure<maximum pressure.

It can be seen from Equation 2 above that the objective function increases 1) when the total operation efficiency E for each unit time in each combustion stage of each boiler increases, decreases 2) when the variance C of the numbers of operation cycles in each combustion stage of each boiler increases, and decreases 3) when the variance D of the durations of each operation cycle in each combustion stage of each boiler increases.

That is, the above objective function may allow the pressures of the boilers 10-1, 10-2, . . . , 10-N to be controlled such that the driving efficiencies of the boilers 10-1, 10-2, . . . , 10-N increase and frequent changes in the combustion stages of the boilers 10-1, 10-2, . . . , 10-N are reduced.

Limiting the minimum pressure and the maximum pressure is for safety in operating the boilers 10-1, 10-2, . . . , 10-N.

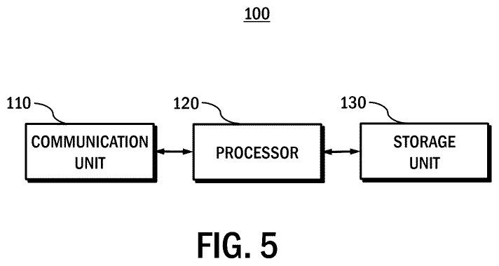

FIG. 5 is a view illustrating a configuration of the boiler control server 100 shown in FIG. 1. The boiler control server 100 according to an embodiment may be implemented by a server system including a communication unit 110, a processor 120, and a storage unit 130 as shown in FIG. 5.

The communication unit 110 may be a communication interface for connecting with an external network or an external device, and may collect operation data of boilers and may transmit boiler pressure control values to the controller 200.

The processor 120 may collect operation data of the boilers 10-1, 10-1, . . . , 10-N, may calculate operation efficiencies and generate statistical data according to changes in the combustion stages, and may adjust pressures of the boilers 10-1, 10-2, . . . , 10-N, respectively, based on the operation efficiencies and the statistical data, according to the procedure illustrated in FIG. 2.

The storage unit 130 may provide a storage space necessary the processor 120 to function and operate.

Up to now, the industrial boiler control method using statistical data according to changes in combustion stages has been described in detail with reference to preferred embodiments.

In the above embodiment, by controlling pressures of industrial boils by further using statistical data according to changes in combustion stages in addition to operation efficiencies, operation efficiencies of boilers may be prevented from being degraded due to frequent changes in the combustion stages for the reasons of a position connected to a steam header, and ultimately, energy consumption required for operating the boilers may be reduced.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. A boiler control method comprising:
collecting operation data of each boiler with respect to a plurality of boilers;
calculating an operation efficiency of each boiler based on the operation data;
generating statistical data of each boiler according to changes in combustion stages from the operation data; and
controlling a pressure of each boiler to optimize an objective function having the operation efficiency and the statistical data as parameters.

2. The boiler control method of claim 1, wherein the boilers are connected to a single steam header.

3. The boiler control method of claim 1, wherein the operation data comprises an operating time, a combustion stage, cumulative water supply, cumulative fuel consumption, a pressure.

4. The boiler control method of claim 3, wherein calculating comprises calculating the operation efficiency for each unit time of each boiler based on the following equation:
$$Boiler Operation Efficiency = ( Cumulative Water Supply for Unit Time ) / ( Cumulative Fuel Consumption for Unit Time ) .$$

5. The boiler control method of claim 1, wherein generating comprises generating the number of operation cycles in each combustion stage of each boiler and a duration of each operation cycle in each combustion stage of each boiler.

6. The boiler control method of claim 5, wherein the operation cycle is a period from when a combustion stage of a boiler changes from a previous combustion stage to when the combustion stage changes to a next combustion stage,
wherein the number of operation cycles in each combustion stage is the number of operation cycles counted for each combustion stage, and
wherein the duration is a time during which an operation cycle remains unchanged.

7. The boiler control method of claim 6, wherein the objective function increases when a total operation efficiency for each unit time in each combustion stage of each boiler increases, and decreases when a variance of the numbers of operation cycles in each combustion stage of each boiler increases.

8. The boiler control method of claim 6, wherein the objective function increases when a total operation efficiency for each unit time in each combustion stage of each boiler increases, and decreases when a variance of the durations of each operation cycle in each combustion stage of each boiler increases.

9. The boiler control method of claim 1, further comprising pre-processing the collected operation data.

10. A boiler control server comprising:
a communication unit configured to collect operation data of each boiler with respect to a plurality of boilers; and
a processor configured to calculate an operation efficiency of each boiler based on the operation data, to generate statistical data of each boiler according to changes in combustion stages from the operation data, and to control a pressure of each boiler to optimize an objective function having the operation efficiency and the statistical data as parameters.

11. A boiler control method comprising:
collecting operation data of each boiler with respect to a plurality of boilers;
generating the number of operation cycles in each combustion stage of each boiler from the operation data of each boiler;
generating a duration of each operation cycle in each combustion stage of each boiler from the operation data of each boiler; and
controlling a pressure of each boiler, based on the number of operation cycles in each combustion state of each boiler and the duration of each operation cycle in each combustion state of each boiler.
